(19) United States
(12) Patent Application Publication
(10) Pub. No.: US 2005/0074583 A1
(43) Pub. Date: Apr. 7, 2005

(54) Replication of a real product using a sample substrate

(75) Inventors: Gary W. Gratopp, Shelby Township, MI (US); David Powell, Cranford, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: The Sample Group Incorporated, Asheville, NC (US)

(21) Appl. No.: 10/677,149

(22) Filed: Oct. 1, 2003

(51) Int. Cl. B32B 1/00

(52) U.S. Cl. 428/174

(57) ABSTRACT

Patterns and contours of part or all of an actual product are reproduced on a sample substrate. The pattern is printed on the substrate, and the substrate is post-pressed to reproduce thereon the three dimensional features of the actual product, including interior contours of the product.

### BACKGROUND OF THE INVENTION

The present invention is directed to replication processes and, more particularly, to the replication of the patterns and contours of an actual product on a substrate.

Presently, manufacturers and sellers of large-sized and/or custom-made products, such as customized kitchens, custom carpentry, roofing, or siding, are not readily able to provide prospective customers with a faithful representation of the final product. As an example, the makers or sellers of custom-made countertops, kitchen cabinets, doors, windows, garage doors, roofing or siding are currently only able to provide customers with four color brochures that include color swatches which can represent the colors or patterns of the custom product, such as but not limited to a wood grain pattern or a marble pattern, but which are unable to convey the three dimensional shape of the custom made product. Thus, prospective customers are provided with professional quality photographs of such items but are not provided with a sense of the other features of a product, such as the shape and appearance of a beveled or curved edge, a groove, or the feel of a soft edge.

Alternatively, the seller or manufacturer may use a portion of an actual item as a sample to convey both the pattern of the custom made item as well as the actual contours and/or shapes of the item. However, because such custom made items are often made of wood, marble, or other heavy and bulky materials, the transport of such items to the home of a prospective customer is clearly inconvenient. Moreover, when a large number of such items are needed to display various possible choices of a large number of products, the use of such samples is clearly impractical.

It is therefore desirable to provide prospective customers with a sample of a custom made or large sized product that can both display the colors and pattern of the surface of the product as well as the three dimensional features of the product.

### SUMMARY OF THE INVENTION

The present invention provides a sample of a real product that replicates both the surface pattern of the product as well as the three-dimensional features of the product in a manner that is readily transportable. The invention also provides the method of manufacturing such a sample.

According to an aspect of the invention, a sample substrate is fabricated that reproduces the appearance of an actual product. A pattern is printed on the sample substrate that comprises a two-dimensional representation of the product. The sample substrate is post-pressed to reproduce thereon the three-dimensional features of the product. The three-dimensional features include interior contours of the product.

According to a further aspect of the invention, a sample substrate reproduces the appearance of an actual product and includes a pattern printed on the sample substrate that represents a pattern formed on the product and includes three-dimensional features formed in the sample substrate that represent the three-dimensional features of the product. The three-dimensional features of the product include interior contours of the product.

The foregoing aspects, features and advantages of the present invention will be further appreciated when considered with reference to the following description of the preferred embodiments and accompanying drawings.

### BRIEF DESCRIPTION OF THE DRAWINGS

FIG. 1 is a diagram showing a process flow in accordance with an aspect of the invention.

FIG. 2 shows a top view of a sample substrate formed in accordance with an aspect of the invention.

FIG. 3 shows a side view of the sample substrate shown in FIG. 2.

FIG. 4 is a diagram showing a cross-sectional view of another sample substrate of the invention which replicates a grainy contour of an original product.

FIG. 5 is a cross-sectional diagram illustrating another sample substrate of the invention which illustrates various interior contour features that are replicated.

### DETAILED DESCRIPTION

The present invention provides a sample substrate that replicates the three-dimensional patterns and contours of an actual product and provides a method of fabricating the sample substrate.

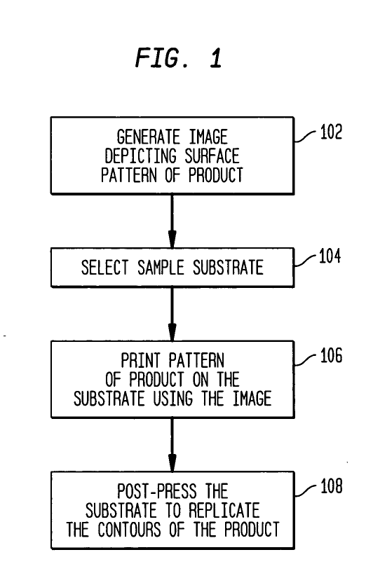

FIG. 1 illustrates an example of the steps carried out in the formation of a sample substrate. As step 102 shows, a two-dimensional image is generated that shows the colors and/or color patterns of a portion of one or more actual products. Next, as step 104 shows, a sample substrate is selected. The sample substrate may be selected from any of a number of known materials, such as paper, cloth, cardboard, leather, metal, wood, plastic, etc. Alternatively, the sample substrate is selected before generating the two-dimensional image.

Then, the image or images are replicated on respective regions of the sample substrate, as shown in step 106. The image or images may be generated and replicated using known methods, such as using lithographic printing, xerographic printing, and/or screen printing. The printed image may be the same size as the original image or may be reduced or enlarged. The color patterns that are printed on the sample substrate may include any pattern that may be present on an original substrate, such as color patterns, wood grain patterns or marble grain patterns.

Thereafter, as step 108 shows, the sample substrate is post-pressed to replicate the contours of the original product. The post-pressing may be carried out in any of a number of methods including embossing and debossing methods. A single pressing tool may be used to emboss or deboss the substrate, or the substrate may be embossed or debossed by pressing the substrate between a pair of pressing tools having complementary shapes.

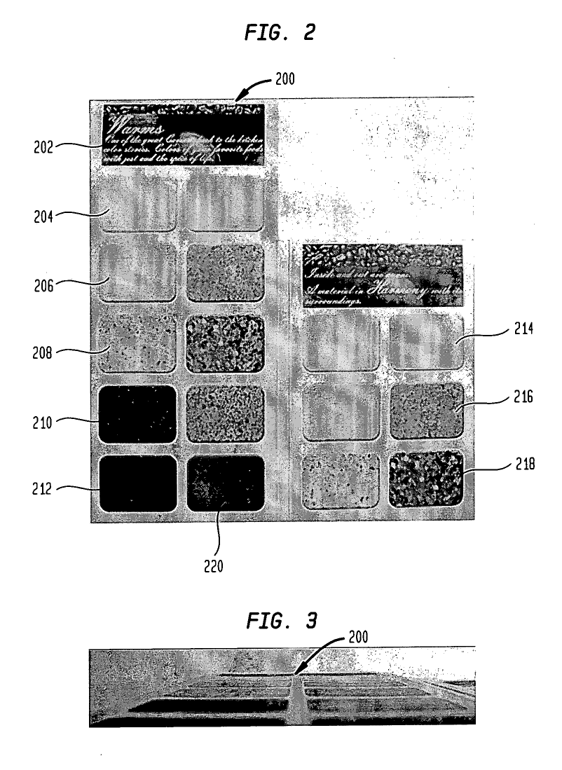

FIGS. 2 and 3 show an example of a sample substrate 200. A plurality of samples 202, 204, . . . , 220 are formed in the substrate 200 in the manner described above. Each of the samples 202, 204, . . . , 220 replicates a color pattern of a respective original product as well as the contours of the product. FIG. 2 is a top view showing the printed color and/or pattern of each of the samples that replicate the colors and/or patterns of original products. FIG. 3 is an oblique side view of the sample substrate 200 that shows the dimensional features of the samples, including the interior contour or grain, that are achieved by embossing or debossing the sample substrate.

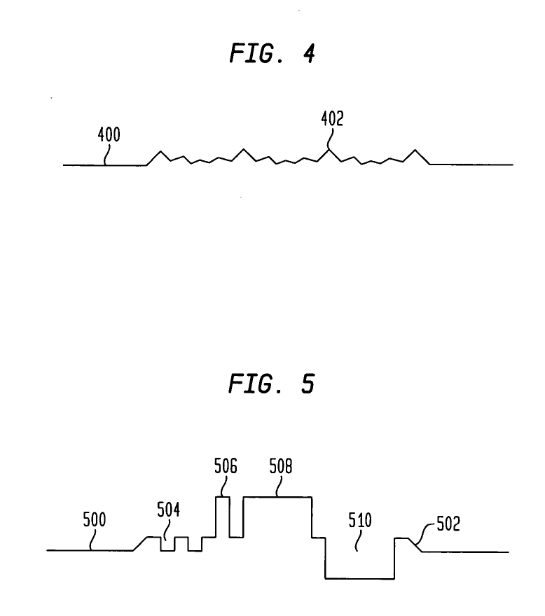

FIG. 4 is a cross-sectional view of another sample substrate 400 of the invention. A sample pattern 402 is printed on the sample substrate 400 and then post-pressed to incorporate the grain pattern of the surface of the original product.

FIG. 5 shows a cross-sectional diagram of a further sample substrate 500 which includes examples of other features that may be replicated in accordance with the invention. A beveled edge may be post-pressed at the border of the sample. One or more grooves 504, columns 506, raised surfaces 508 or lowered surfaces 512 may also be post-pressed in the sample. Additionally, other three-dimensional features may be post-pressed in the sample substrate.

The present invention is particularly suitable for preparing samples that represent manufactured or customized actual products that are too large, too heavy and/or too expensive to be transported to a customer or to be displayed in a store. The customer is thus provided with both a representation of the appearance of the actual product as well as the shape of the product.

The invention is particularly suitable for providing samples of custom-made items such as countertops, kitchen cabinets, sinks and other plumbing fixtures, doors, windows, garage doors, roofing, siding, matboards, etc. An actual-sized sample of a portion of a product or a reduced-sized sample of a part or all of a product may be formed in the manner of the invention to provide customers with representations of both the color pattern that the custom-made product would have as well as the contours of the surfaces and the shapes to be formed in the custom-made product.

Additionally, the sample substrate of the invention may be used to replicate products formed of marble, stone, or other materials that are too heavy to be easily transported. The sample is instead formed on a much lighter material, such as paper, cloth, cardboard, leather, metal, wood, plastic, etc., that is much easier to transport but which nevertheless represents the appearance and shapes of the original product.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of fabricating a sample substrate that reproduces the appearance of an actual product, said method comprising:
printing a pattern on said sample substrate that comprises a two-dimensional representation of the product; and
post-pressing said sample substrate to reproduce thereon the three-dimensional features of the product, said three-dimensional features including interior contours of the product.

2. The method of claim 1 wherein said printing step is selected from the group consisting of: lithographically printing said pattern on said sample substrate, xerographically printing said pattern on said sample substrate, and screen printing said pattern on said sample substrate.

3. The met hod of claim 1 wherein said post-pressing step is selected from the group consisting of: embossing said sample substrate, and debossing said sample substrate.

4. The method of claim 1 wherein said post-pressing step includes pressing said sample substrate with a single pressing tool.

5. The met hod of claim 1 wherein said post-pressing step is carried out by pressing said sample substrate between a complementary shaped pair of pressing tools.

6. The method of claim 1 wherein said sample substrate is selected from the group consisting of: paper, cloth, cardboard, leather, wood, metal and plastic.

7. The method of claim 1 wherein said pattern is selected from the group consisting of: a color pattern, a wood grain pattern, a marble pattern, and a contour pattern.

8. The method of claim 1 wherein said three-dimensional features are selected from the group consisting of: a beveled edge, a groove, a column, a raised surface, and a lowered surface.

9. The method of claim 1 wherein said printing step includes printing a two-dimensional pattern having actual dimensions of the product, and said post-pressing reproduces three-dimensional features having actual dimensions of the product.

10. The method of claim 1 wherein said printing step includes printing a two-dimensional pattern having a reduced or enlarged size with respect to that of the product, and said post-pressing reproduces said three-dimensional features having reduced or enlarged dimensions with respect to those of the product.

11. The method of claim 1 wherein said printing step includes printing a plurality of patterns at respective locations on said sample substrate, each of said plurality of patterns comprising a two-dimensional representation of a respective one of said plurality of products, and said post-pressing step includes reproducing said three-dimensional features of each of said plurality of products including interior contours of each product.

12. A sample substrate that reproduces the appearance of an actual product, said sample substrate being formed using a method comprising:
printing a pattern on said sample substrate that comprises a two-dimensional representation of the product; and
post-pressing said sample substrate to reproduce thereon the three-dimensional features of the product, said three-dimensional features including interior contours of the product.

13. The sample substrate of claim 12 wherein said printing step is selected from the group consisting of: lithographically printing said pattern on said sample substrate, xerographically printing said pattern on said sample substrate, and screen printing said pattern on said sample substrate.

14. The sample substrate of claim 12 wherein said post-pressing step is selected from the group consisting of: embossing said sample substrate, and debossing said sample substrate.

15. The sample substrate of claim 12 wherein said post-pressing step includes pressing said sample substrate with a single pressing tool.

16. The sample substrate of claim 12 wherein said post-pressing step is carried out by pressing said sample substrate between a complementary shaped pair of pressing tools.

17. The sample substrate of claim 12 wherein said sample substrate is selected from the group consisting of: paper, cloth, cardboard, leather, wood, metal and plastic.

18. The sample substrate of claim 12 wherein said pattern is selected from the group consisting of: a color pattern, a wood grain pattern, a marble pattern, and a contour pattern.

19. The sample substrate of claim 12 wherein said three-dimensional features are selected from the group consisting of: a beveled edge, a groove, a column, a raised surface, and a lowered surface.

20. The sample substrate of claim 12 wherein said printing step includes printing a two-dimensional pattern having actual dimensions of the product, and said post-pressing reproduces three-dimensional features having actual dimensions of the product.

21. The sample substrate of claim 12 wherein said printing step includes printing a two-dimensional pattern having a reduced or enlarged size with respect to that of the product, and said post-pressing reproduces said three-dimensional features having reduced or enlarged dimensions with respect to those of the product.

22. The sample substrate of claim 12 wherein said printing step includes printing a plurality of patterns at respective locations on said substrate, each of said plurality of patterns comprising a two-dimensional representation of a respective one of said plurality of products, and said post-pressing step includes reproducing said three-dimensional features of each of said plurality of products including interior contours of each product.

23. A sample substrate that reproduces the appearance of an actual product, said sample substrate comprising:
a pattern printed on said sample substrate and representing a pattern formed on the product; and
three-dimensional features formed in said sample substrate representing the three-dimensional features of the product, said three-dimensional features including interior contours of the product.

24. The sample substrate of claim 23 wherein said pattern is selected from the group consisting of: a lithographic print, a xerographic print, and a screen print.

25. The sample substrate of claim 23 wherein said three-dimensional features are selected from the group consisting of: embossed features, and debossed features.

26. The sample substrate of claim 23 wherein said substrate is selected from the group consisting of: paper, cloth, cardboard, leather, wood, metal and plastic.

27. The sample substrate of claim 23 wherein said pattern is selected from the group consisting of: a color pattern, a wood grain pattern, a marble pattern, and a contour pattern.

28. The sample substrate of claim 23 wherein said three-dimensional features are selected from the group consisting of: a beveled edge, a groove, a column, a raised surface, and a lowered surface.

29. The sample substrate of claim 23 wherein said pattern has actual dimensions of the product, and said three-dimensional features have actual dimensions of the product.

30. The sample substrate of claim 23 wherein said pattern has a reduced or enlarged size with respect to that of the product, and three-dimensional features have reduced or enlarged dimensions with respect to those of the product.

31. The sample substrate of claim 23 wherein said substrate includes a plurality of patterns at respective locations on said substrate, each of said plurality of patterns comprising a two-dimensional representation of a respective one of said plurality of products, and said three-dimensional features include said three-dimensional features of each of said plurality of products including interior contours of each product.
